(19) United States
(12) Patent Application Publication
(10) Pub. No.: US 2022/0044097 A1
(43) Pub. Date: Feb. 10, 2022

(54) BOOLEAN SATISFIABILITY PROBLEM SOLVING USING RESTRICTED BOLTZMANN MACHINES

(71) Applicant: DeepMind Technologies Limited, London (GB)

(72) Inventors: Xujie Si, Philadelphia, PA (US); Vinod Nair, London (GB); Yujia Li, London (GB); Felix Axel Gimeno Gil, London (GB)

(21) Appl. No.: 17/390,512

(22) Filed: Jul. 30, 2021

Related U.S. Application Data
(60) Provisional application No. 63/061,046, filed on Aug. 4, 2020.

(51) Int. Cl. G06N 3/04; G06N 3/08

(52) U.S. Cl. CPC G06N 3/0445; G06N 3/08

(57) ABSTRACT

Methods, systems, and apparatus, including computer programs encoded on computer storage media, for satisfiability solving for Boolean formulas. One of the methods includes receiving a request to determine whether an input Boolean formula is satisfiable according to a set of satisfiability criteria; processing the input Boolean formula using a formula model that is configured to receive, as input, the input Boolean formula, and to generate, as output, a satisfiability probability distribution over assignments of values to the literals in the clauses of the input Boolean formula; determining whether the input Boolean formula is satisfiable; sampling, using the satisfiability probability distribution, an assignment of values to the literals in the clauses of the input Boolean formula, and determining whether the assignment of values satisfies the set of satisfiability criteria.

### CROSS-REFERENCE TO RELATED APPLICATION

This application claims priority to U.S. Provisional Application No. 63/061,046, filed on Aug. 4, 2020. The disclosure of the prior application is considered part of and is incorporated by reference in the disclosure of this application.

### BACKGROUND

This specification relates to Boolean satisfiability problem solving using machine learning models.

Neural networks are machine learning models that employ one or more layers of nonlinear units to predict an output for a received input. Some neural networks are deep neural networks that include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

In this specification, a Boolean formula is a conjunction of one or more clauses. Each clause is a disjunction of one or more literals, i.e., the Boolean formula is in conjunctive normal form. Each literal of the formula can represent one of two values indicating TRUE or FALSE, respectively. Formula 1, below, is an example of a formula in conjunctive normal form:

b₁∧(b₂∨b₃) ∧(b₂∨b₄∨˜b₅) FORMULA 1

Formula 1 includes three clauses. A clause includes one or more literals, and clauses in the same formula can share literals, e.g., b₂ appears in both the second and third clause of Formula 1. In this specification, “∧” represents a logical conjunction between two operands, i.e., a literal or a clause; “∨” represents a logical disjunction between two operands; and “˜” represents a logical negation of an operand.

An assignment to an input Boolean formula is a tuple of values indicating either TRUE or FALSE, with a value assigned to each literal in the formula. Formula 1 includes five distinct literals, <b₁, b₂, b₃, b₄, b₅>. One example of an assignment for Formula 1 is <1, 0, 1, 0, 1>. An assignment that causes a Boolean formula to evaluate to TRUE is said to satisfy the formula. Depending on the satisfiability criteria of a particular satisfiability problem, determining whether the Boolean formula is satisfiable according to the given problem requires finding one or more satisfying assignments.

The Boolean Satisfiability Problem (“SAT”) is a problem in computer science: given a Boolean formula B with a plurality of Boolean literals b₁, b₂ . . . bₙ, find an assignment for each literal, e.g., 0 or 1, that causes the formula to evaluate to TRUE. If such an assignment of values exists, then the formula B is considered satisfiable, otherwise the formula is considered unsatisfiable.

The Sharp Satisfiability Problem (“#SAT”) is another problem in computer science.

Rather than finding a satisfying assignment for a formula B, as in SAT, #SAT is a counting problem to find every satisfying assignment for a formula B.

The Maximum Satisfiability Problem (“MAX-SAT”) is another problem in computer science: given a Boolean formula B with a plurality of Boolean literals b₁, b₂ . . . bₙ, find the assignment that satisfies the most clauses of the formula B. In some cases, there might not be an assignment that causes a formula B to evaluate to TRUE.

### SUMMARY

This specification describes technologies for determining whether an input Boolean formula is satisfiable according to a satisfiability problem, such as SAT. A satisfiability problem defines one or more satisfiability criteria. An input Boolean formula is satisfiable if there exists one or more assignments of inputs to the formula that cause the input Boolean formula to meet the satisfiability criteria.

The subject matter described in this specification can be implemented in particular implementations so as to realize one or more of the following advantages.

An input Boolean formula can be determined to be satisfiable according to a satisfiability problem more efficiently than using conventional techniques, even when the satisfiability problem is computationally intractable, e.g., SAT, #SAT, and MAX-SAT, as well as their respective variants. A satisfiability solver can be implemented using technologies described in this specification and used for a variety of applications, e.g., testing circuit designs, scheduling or routing different entities according to a set of criteria, and optimizing a model for a dynamic system subject to one or more operating constraints.

A satisfiability probability distribution is generated and sampled to generate satisfying assignments using hardware accelerators, by performing specific operations optimized for performance by the accelerators. By generating and sampling the distribution by performing the optimized operations, the described technologies can improve performance over conventional techniques implemented on the same hardware accelerators. In other words, the described techniques are optimized to run on multiple hardware accelerators, resulting in the satisfiability problem being solved much quicker and, in some cases, resulting satisfiability problems that were previously believed to be unsolvable to be able to be solved in an appropriate amount of time.

More specifically, the techniques described in this specification can be efficiently performed on hardware accelerators that are optimized to perform particular operations including matrix multiplication, sigmoid functions and other non-linear functions, sampling Bernoulli random variables, and other operations used in efficiently processing machine learning models. In other words, unlike in other approaches, the described techniques are designed to be made up of primitive operations that are already optimized on hardware accelerators, thereby allowing the hardware accelerators to train and execute a model and to generate satisfiability probability distributions.

By using these primitive operations, the techniques described can be implemented without special configuration to existing hardware, merely requiring the execution of a sequence of operations the hardware is already configured to execute efficiently, to generate the distribution of assignments for a Boolean formula. For example, the described techniques can be implemented on ASICs, e.g., hardware accelerators such as Tensor Processing Units (TPUs) configured to perform efficient matrix multiplication operations and other operations related to processing machine learning models. The described techniques are well-suited for implementation on hardware accelerators at least for these reasons.

A formula model generating a distribution is generated specifically for an input Boolean formula from clause models. The clause models can be generated, offline, to generate satisfiability probability distributions for clauses of different lengths. A library of such clause models can be generated offline and used to quickly generate a formula model online and in response to a request.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example satisfiability solver system.

FIG. 2 is a flowchart of an example process for generating a formula model for an input Boolean formula.

FIG. 3 is a flowchart of an example process for determining whether an input Boolean formula is satisfiable.

Like reference numbers and designations in the various drawings indicate like elements.

### DETAILED DESCRIPTION

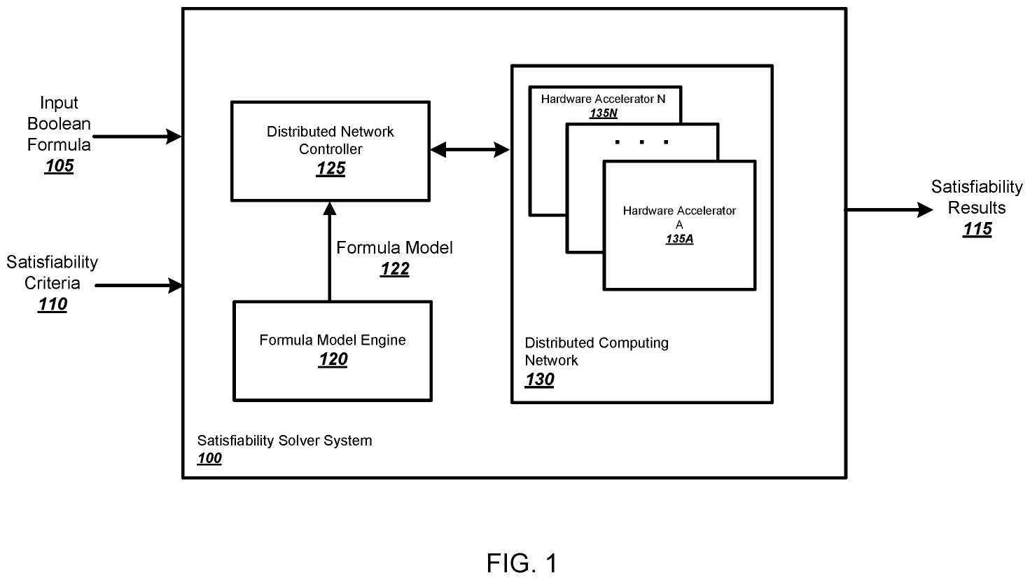

FIG. 1 shows an example satisfiability solver system 100. The system 100 is an example of a system implemented as computer programs on one or more computers in one or more locations, in which the systems, components, and techniques described below can be implemented.

The system receives a request that includes an input Boolean formula 105 and one or more satisfiability criteria 110, and generates satisfiability results 115 in response to the request. The system 100 includes a formula model engine 120, a distributed network controller 125, and a distributed computing network 130. The network 130 includes a plurality of hardware accelerators 135A-N that are configured to communicate with the distributed network controller 125.

The Boolean formula 105 can be a formula generated from one or more other systems connected to the system 100, e.g., over a wired or wireless network. The system 100 can be implemented as a satisfiability solver that is part of a larger system configured to generate Boolean formulas. The Boolean formulas can represent a large number of different variables, e.g., millions of variables, and logical constraints between each variable.

For example, an input Boolean formula can represent configuration options for a physical facility, with different logical constraints, represented as conjunctions, disjunctions, and negations, each representing a relationship between different configuration options.

As another example, the input Boolean formula can be a logical representation of a circuit, e.g., a circuit on a printed circuit board slated for manufacturing. The system 100 can process a formula to determine whether the formula is satisfiable, as part of a process for optimizing a circuit before manufacturing resources are committed, e.g., by a manufacturing system, to produce efficient circuits corresponding to the formula. A formula corresponding to a physical circuit can be produced, e.g., using conventional techniques for translating a Boolean formula into a circuit that includes a combination of logical gates, e.g., AND, NOT,

OR, NAND, NOR, XOR gates. The system 100 or another system can optimize the formula according to one or more optimization criteria, e.g., fewer clauses or a formula that can be expressed more efficiently as a physical circuit. In this case, the optimization is constrained by the existence of a satisfying assignment. At each step of optimization, the system 100 can process an intermediate formula to determine whether it is satisfiable according to one or more satisfiability criteria. If so, the system 100 or another system can iterate the optimization process again, with the intermediate formula. If the intermediate formula is not satisfiable according to the system 100, then the system optimizing for the physical circuit can revert back to a previous intermediate formula, and send that formula for manufacturing a physical circuit.

As a preprocessing step to generating a physical circuit, a formula that the system 100 determines to be satisfiable can be analyzed, e.g., by the system 100 or another appropriately configured system, for potential simplifications to the formula, e.g., by removing redundant literals that do not affect the output of the formula for any given input. In some implementations and as described below, the system 100 always analyzes the formula 105 for potential simplifications before determining whether it is satisfiable.

The system 100 can be used in configuration management processes to optimize a configuration of a complex system, e.g., a manufacturing system, a software system, or an IT system, which can include several interconnected components and constraints indicating which of the components are and are not compatible with one other, or are necessary for the operation of the complex system.

The formula can also represent scheduling constraints between entities, e.g., employees with different qualifications and job responsibilities that must be fulfilled by certain qualifications throughout a given time period. Literals can represent entities and clauses in the formula can represent whether entities can or cannot be scheduled together. Once the formula is written, the system 100 can process and determine whether the formula is satisfiable. A satisfiable formula indicates a valid scheduling arrangement for the entities given the constraints.

The scheduling arrangement can be implemented, or alternatively, modified according to one or more optimizing criteria to yield a better scheduling arrangement according to the optimizing criteria. The system 100 can process the formula corresponding to the new scheduling arrangement, determine whether it is satisfiable or not, and repeat the optimization with the updated formula.

As another example, a software system can be represented as a Boolean Formula, where each literal represents a component and each clause represents a logical constraint, e.g., component A must be implemented with component C, but not with component D, and so on. Configuration management of the software system seeks to optimize the architecture or design of the software system, while still ensuring that the software system continues to perform as required. For example, optimization criteria for configuration of the software system can include minimizing the number of components present in the software system, without compromising functionality.

In general and as described in more detail, below, the system 100 determines whether the formula 105 is satisfiable according to the one or more satisfiability criteria 110. The formula 105 is considered satisfiable when the formula 105 satisfies the satisfiability criteria 110. The system 100 is configured to receive satisfiability criteria that represent a satisfiability problem, e.g., SAT and its variants, MAX-SAT and its variants, and #SAT and its variants. For example, if the satisfiability criteria 110 define SAT, then the input Boolean formula 105 is determined to be satisfiable if the system 100 identifies at least one satisfying assignment.

In some implementations, the satisfiability criteria 110 represents a counting problem, i.e., a problem that asks how many satisfying assignments exist, rather than whether a single satisfying assignment exists. In those implementations, the system 100 continues operating even after determining a satisfying assignment, e.g., for a predetermined period of time before stopping or until a maximum number of satisfying assignments have been found.

For example, the satisfiability criteria 110 can define the #SAT problem or its variants. If the satisfiability criteria 110 defines the #SAT problem, then the system 100 is configured to determine different assignments that satisfy the formula 105. A satisfiable formula under the #SAT problem is a formula that has at least one satisfying assignment. However, unlike for the SAT problem, the system 100 is configured to continue identifying unique satisfying assignments for the formula 105 until reaching a stopping condition, e.g., a time limit.

In some implementations, the satisfiability criteria 110 defines the MAX-SAT problem or its variants. In these implementations, the system 100 is configured to determine an assignment that satisfies the most number of clauses of the formula 105. The system 100 is configured to continue identifying assignments for the formula 105 that satisfy higher and higher numbers of clauses of the formula 105, up until the system 100 reaches a stopping condition or until the system 100 identifies a satisfying assignment for the input formula 105, i.e., an assignment which satisfies every clause in the formula 105.

In some implementations, the criteria 110 are predetermined, i.e., are the same for every formula 105 that is received by the system 100, and the system 100 only receives the formula 105.

When the satisfiability criteria 110 define the SAT problem or its variants, the satisfiability results 115 represent whether the system 100 determined the formula 105 to be satisfiable according to the criteria 110. The satisfiability results 115 also include the satisfying assignment for the formula 105. If the system 100 was unable to find satisfying assignments for the formula 105, i.e., within a predetermined period of time, then the satisfiability results 115 can include an indication that the formula 105 is not satisfiable.

When the satisfiability criteria 110 define the MAX-SAT problem or its variants, the satisfiability results 115 include the assignment for the formula 105 determined by the system 100 to satisfy the highest number of clauses in the formula 105. In some cases, the satisfiability results 115 include an assignment to the formula 105 that satisfies every clause in the formula 105, and is therefore also a satisfying assignment under the SAT problem. If the system 100 is unable to find an assignment that satisfies at least two clauses in the formula 105, then the satisfiability results 115 can include an indication that the formula 105 is not satisfiable.

When the satisfiability criteria 110 define the #SAT problem or its variants, the satisfiability results 115 include each satisfying assignment determined by the system 100 to satisfy the formula 105. If the system 100 is unable to find at least one assignment that satisfies the formula 105, then the satisfiability results 115 can include an indication that the formula 105 is not satisfiable.

The system 100 is configured to send the results 115 to a computing device, e.g., to a user-operated device with a display, or to another system that initially sent the request with the formula 105 and the criteria 110. The computing device can display the results 115 to a user, and/or provide the results 115 to another system for additional processing.

The formula model engine 120 is configured to generate a formula model 122 for the Boolean formula 105. A formula model is a model trained to receive, as input, a Boolean formula, and to generate, as output, a satisfiability probability distribution over assignments to the Boolean formula 105. A satisfiability probability distribution is a probability distribution over all possible assignments for the input Boolean formula 105. Due to the manner in which the formula model has been trained, when the distribution is sampled, the probability of sampling assignments that satisfy the input Boolean formula will be higher than assignments that do not satisfy the input Boolean formula. How the formula model engine 120 generates the formula model 122 for the formula 105 is described below.

The distributed network controller 125 is configured to receive the formula model 122. The distributed network controller 125 is configured to schedule operations to be performed on hardware accelerators 135A-N of the distributed computing network, including scheduling operations for iteratively sampling the distribution defined by the formula model 122.

A hardware accelerator is a computing device that includes specialized hardware for performing certain types of operations, e.g., matrix multiplication, sigmoid functions, and Bernoulli trials, more efficiently over non-specialized—or “general purpose”—computing devices. In other words, hardware accelerators are generally more computationally efficient than their general purpose counterparts at performing the types of operations for which they are optimized.

Hardware accelerators can include one or more different types of processing units, e.g., central processing units (“CPUs”), graphics processing units (“GPUs”), and tensor processing units (“TPUs”), as well as other forms of special-purpose logic circuitry, such as field-programmable gate arrays (“FPGAs”), and application-specific integrated circuits (“ASICs”). The distributed computing network 130 can include hardware accelerators of different types, and/or hardware accelerators having the same types of processing units, but of different generations, e.g., a combination of first-generation TPUs, second-generation TPUs, and third-generation TPUs.

The hardware accelerators 135A-N are configured to efficiently perform any sequence of operations that includes operations the hardware accelerators are specialized to perform, e.g., a sequence of operations for training and processing a machine learning model by performing matrix multiplication and computing an activation function, such as sigmoid. As another example, the sequence of operations include sampling from a distribution, e.g., using a Monte Carlo method.

As described in more detail, below, the distributed network controller 125 is configured to cause each of one or more hardware accelerators in the distributed computing network 130 to sample the satisfiability probability distribution generated as output of the formula model 122, e.g., using multiple chains generated using Markov Chain Monte Carlo. After sampling the formula model 122, a corresponding hardware accelerator can evaluate the assignment to determine whether it satisfies the input formula, or alternatively, pass the assignment to the distributed network controller 125 to determine whether the assignment satisfies the formula 105.

When the satisfiability criteria 110 defines the SAT problem, if a hardware accelerator samples an assignment to the formula 105 and the system 100 determines the assignment satisfies the formula 105, the controller 125 causes the distributed computing network to stop processing because the satisfiability criteria 110 have been met.

When the satisfiability criteria defines the MAX-SAT problem, if a hardware accelerator samples an assignment to the formula 105 and the system 100 determines the assignment satisfies at least two clauses of the formula 105, then the system 100 next determines if the assignment satisfies the highest number of clauses out of all previously determined assignments to the formula 105. If so, the system 100 tracks the assignment as part of the satisfiability results 115. The system 100 continues sampling assignments to determine assignments that satisfy the highest number of clauses in the formula 105, until reaching some stopping condition, e.g., a period of time or a number of iterations, or until sampling a satisfying assignment for the formula 105.

When the satisfiability criteria defines the #SAT problem, if a hardware accelerator samples an assignment to the formula 105, then the system 100 next determines if the assignment satisfies the formula 105. If so, the system 100 tracks the assignment as part of the satisfiability results 115, if the assignment is not already recorded in the results 115. The system 100 continues sampling assignments to determine satisfying assignments for the formula 105, until reaching some stopping condition.

If the controller 125 does not receive an indication of a satisfying assignment from the distributed computing network within a predetermined condition, e.g., a period of time or a threshold number of sampling iterations by the hardware accelerators, then the system 100 generates the satisfiability results 115 to indicate that the Boolean formula 105 is not satisfiable.

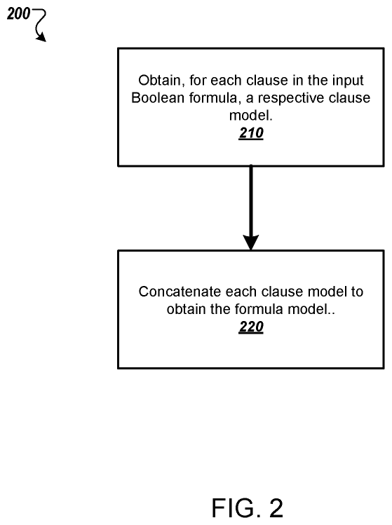

FIG. 2 is a flowchart of an example process 200 for generating a formula model for an input Boolean formula. For convenience, the process 200 will be described as being performed by a system of one or more computers, located in one or more locations, and programmed appropriately in accordance with this specification. For example, a satisfiability solver system, e.g., the satisfiability solver system 100 of FIG. 1, appropriately programmed, can perform the process 200.

The system obtains 210, for each clause in the input Boolean formula, a respective clause model. As will be described below, the system can obtain a respective clause model for each clause by (i) training the respective clause model, (ii) obtaining the respective clause model from a library of pre-trained models, or (iii) both.

A clause model is a Restricted Boltzmann Machine (RBM) network. An RBM network is a feed-forward neural network that defines a joint distribution between all possible values of a visible layer (denoted by a vector v), with all possible values of a hidden layer in the RBM network (denoted by a vector h). In general, RBM networks are associated with an energy function E(v, h), and the probability distribution defined by the RBM network is a function of the energy function. The variable v represents a vector of values for the visible units in the visible layer of the RBM network, while the variable h represents a vector of values for the hidden units in the hidden layer of the RBM network. A higher value for E(v, h) corresponds to a lower probability according to the probability distribution, while a lower value for E(v, h) corresponds to a higher probability according to the distribution. The visible layer of a clause model includes a plurality of visible units, and the hidden layer includes a plurality of hidden units. No visible unit is interconnected with any other visible unit, and no hidden unit is interconnected with any other hidden unit. For a clause model of v visible units and h hidden units, the formula model can be represented by a v*h matrix of weights, as well bias vectors b, c for vectors v, h representing the visible and hidden units, respectively. RBMs and RBM networks are discussed in more detail in Martens, et al., On the Representational Efficiency of Restricted Boltzmann Machines, Advances in Neural Information Processing Systems 26 (2013).

In a clause model, a visible layer includes one visible unit for each unique literal in the clause. The visible unit takes as input one of two values representing TRUE or FALSE, e.g., 0 or 1. For example, if the input Boolean formula has three clauses, then the system generates three clause models. If an example clause is “x∨y∨z,” then the corresponding clause model will have three visible units, because the clause has three unique elements, x, y, z. In this specification, the number of unique literals in a clause is referred to as the length of the clause. In other words, the number of visible units in a clause model depends on the length of the corresponding clause.

In some implementations, as a pre-processing step, the system simplifies a clause based on rules of propositional logic, e.g., if a clause is “x∨x∨y,” then the system can simplify the expression to “x∨y,” because of a property of disjunction in propositional logic. Also in this example, the length of the clause is two, whether or not the system is configured to simplify the clause.

The number of hidden units in the clause model can be a function of the length of the clause of the input Boolean formula, e.g., 2k+1 or k² for a clause of length k.

To generate a clause model, the system first defines a free energy function for the model. The free energy function takes as input, an assignment of values x for the clause, and returns an energy associated with the assignment. Note that the free energy function for a clause model differs from an energy function, in that the free energy function is a function only of values for the visible layer to the model.

The free energy function is defined as (i) 0, when an input assignment x does not satisfy the clause; and (ii) −S, when x satisfies the clause, where S is a positive value. Exactly one assignment will not satisfy the clause, because the clause is a disjunction. Every other possible assignment of the clause will satisfy the clause, therefore the free energy function is a Boolean function of possible outputs (0, −S). The free energy function performs as an k-input OR gate, where k is the length of the clause, an output of 0 indicates the clause evaluated to FALSE for an assignment, and an output of −S indicates the clause evaluated to TRUE for an assignment.

After defining the free energy function, the system generates the clause model as an RBM network that defines a distribution that represents a k-input OR gate, using the free energy function. The system can learn the probability distribution by training the RBM network, e.g., using a supervised learning technique. The system can train the clause model on a set of labeled assignments for the clause, where the label is whether the assignment satisfies the clause or not. For each training example or batch of training examples in the set of assignments, the system can train the clause model by computing a loss, i.e., against an assignment sampled using the distribution defined in the clause model and a ground-truth label for that assignment as satisfying or not satisfying, and can update weights of the model after calculating the loss, e.g., using a backpropagation technique.

In some implementations, the RBM network is generated according to any conventional technique for constructing an RBM network from a free energy function that is also a Boolean function. Details about constructing RBM networks with Boolean free energy functions can be found in Wu, et al., On the Representational Power of Restricted Boltzmann Machines for Symmetric Functions and Boolean Functions, IEEE Transactions on Neural Networks and Learning Systems, VOL. 30, NO. 5, MAY 2019.

In some implementations, the system generates a number of RBM networks offline, before receiving a request. The system maintains a repository of generated clause models, and in response to a request to generate a clause model for a clause of a certain length, checks the repository for a pre-existing clause model for a clause of that same length. If the system does not find a clause model for the length of the clause, then system proceeds to generate the clause model. Thereafter, the system can store the generated clause model in the repository for future use.

Returning to FIG. 2, the system concatenates 220 each clause model to generate the formula model for the input Boolean formula. The formula model is also an RBM network with a visible layer and a hidden layer. The visible layer includes each visible unit of each clause model of the concatenated clause models. Similarly, the hidden layer of the formula model includes each hidden unit of each of the concatenated clause models. Each visible unit of the formula model is interconnected with each hidden unit of the formula model. If an interconnection is between a visible unit and hidden unit of two different clause models, the system assigns a random weight to the interconnection.

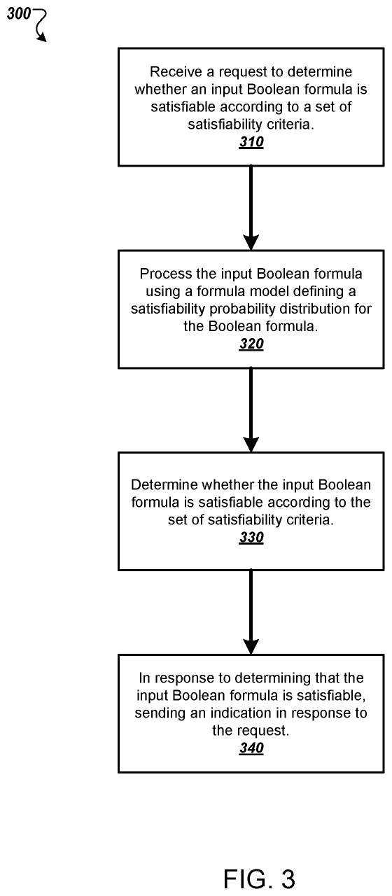

The formula model can be used to begin sampling satisfying assignments for the input Boolean formula, as described below with reference to FIG. 3. In some implementations, after the formula model is generated by concatenating the clause models, the system trains the formula model starting from model parameter values defined for each of the concatenated clause models. Similar to training clause models, as described above, the system can train the formula model according to any conventional training technique for training an RBM network.

FIG. 3 is a flowchart of an example process 300 for determining whether an input Boolean formula is satisfiable according to satisfiability criteria. For convenience, the process 300 will be described as being performed by a system of one or more computers, located in one or more locations, and programmed appropriately in accordance with this specification. For example, a satisfiability solving system, e.g., the satisfiability solving system 100 of FIG. 1, appropriately programmed, can perform the process 300.

The system receives 310 a request to determine whether an input Boolean formula is satisfiable according to a set of satisfiability criteria defined by the satisfiability problem.

For example, the satisfiability problem can be SAT or a variant of SAT. The input Boolean formula includes literals in a plurality of clauses arranged in conjunctive normal form.

The system processes 320 the input Boolean formula using a formula model defining a satisfiability probability distribution for the Boolean formula. In particular, the system samples a satisfiability probability distribution using a plurality of hardware accelerators that each receive and sample from the probability distribution. The system initializes batches of assignments, e.g., by randomly sampling from a distribution of all possible assignments to the formula, and provides the batches to the hardware accelerators. The hardware accelerators, beginning with the assignments in the batches, iteratively sample the satisfiability probability distribution.

The hardware accelerators can employ any conventional technique for sampling probability distributions defined by an RBM, e.g., Gibbs sampling, sampling using periodic unit propagation. In some implementations, the system additionally uses an annealing schedule on the temperature of the probability distribution as part of sampling the distribution. The system can implement different sampling techniques depending on the satisfiability criteria. For example, if the satisfiability criteria define #SAT, then the system samples assignments using annealed importance sampling.

The system determines 330 whether input Boolean formula is satisfiable according to the set of satisfiability criteria. As described above with reference to FIG. 1, the system is configured to receive an assignment sampled by a hardware accelerator as part of processing the input Boolean formula (320). The system determines that the assignment satisfies the satisfiability criteria, by evaluating the Boolean formula according to the assignment.

In response to determining that the input Boolean formula is satisfiable, the system sends 340 an indication in response to the request. As described above with reference to FIG. 1, if the satisfiability criteria require identifying a single assignment, e.g., such as in SAT, then the system sends the indication and causes the hardware accelerators to stop sampling the satisfiability probability distribution.

In some implementations, the formula model—and resulting satisfiability probability distribution—of an input formula can be used to bootstrap a local search solver implementing a local search algorithm for finding a satisfying assignment for the input formula. Specifically, the satisfiability solver system 100 can implement a local search solver that receives, as input, an input formula and an assignment sampled from a corresponding satisfiability probability distribution for the input formula, and generates, as output, a satisfying assignment for the input formula. In general, the local search solver implements one of a plurality of algorithms for processing an initial assignment to identify a satisfying assignment. The local search solver can benefit from the higher probability of an initial assignment provided being a satisfying assignment, because the system samples the initial assignment from the corresponding probability distribution for the input formula. The local search solver can implement any conventional local search algorithm for identifying satisfying assignments for an input formula, e.g., hill climbing algorithms such as greedy SAT (GSAT), random walk algorithms such as simulated annealing, and the Sparrow local search solver.

Embodiments of the subject matter and the actions and operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions, encoded on a computer program carrier, for execution by, or to control the operation of, data processing apparatus. The carrier may be a tangible non-transitory computer storage medium. Alternatively or in addition, the carrier may be an artificially-generated propagated signal, e.g., a machine-generated electrical, optical, or electromagnetic signal, that is generated to encode information for transmission to suitable receiver apparatus for execution by a data processing apparatus. The computer storage medium can be or be part of a machine-readable storage device, a machine-readable storage substrate, a random or serial access memory device, or a combination of one or more of them. A computer storage medium is not a propagated signal.

The term “data processing apparatus” encompasses all kinds of apparatus, devices, and machines for processing data, including by way of example a programmable processor, a computer, or multiple processors or computers. Data processing apparatus can include special-purpose logic circuitry, e.g., an FPGA (field programmable gate array), an ASIC (application-specific integrated circuit), or a GPU (graphics processing unit). The apparatus can also include, in addition to hardware, code that creates an execution environment for computer programs, e.g., code that constitutes processor firmware, a protocol stack, a database management system, an operating system, or a combination of one or more of them.

A computer program can be written in any form of programming language, including compiled or interpreted languages, or declarative or procedural languages; and it can be deployed in any form, including as a stand-alone program, e.g., as an app, or as a module, component, engine, subroutine, or other unit suitable for executing in a computing environment, which environment may include one or more computers interconnected by a data communication network in one or more locations.

A computer program may, but need not, correspond to a file in a file system. A computer program can be stored in a portion of a file that holds other programs or data, e.g., one or more scripts stored in a markup language document, in a single file dedicated to the program in question, or in multiple coordinated files, e.g., files that store one or more modules, sub-programs, or portions of code.

The processes and logic flows described in this specification can be performed by one or more computers executing one or more computer programs to perform operations by operating on input data and generating output. The processes and logic flows can also be performed by special-purpose logic circuitry, e.g., an FPGA, an ASIC, or a GPU, or by a combination of special-purpose logic circuitry and one or more programmed computers.

Computers suitable for the execution of a computer program can be based on general or special-purpose microprocessors or both, or any other kind of central processing unit.

Generally, a central processing unit will receive instructions and data from a read-only memory or a random access memory or both. The essential elements of a computer are a central processing unit for executing instructions and one or more memory devices for storing instructions and data. The central processing unit and the memory can be supplemented by, or incorporated in, special-purpose logic circuitry.

Generally, a computer will also include, or be operatively coupled to, one or more mass storage devices, and be configured to receive data from or transfer data to the mass storage devices. The mass storage devices can be, for example, magnetic, magneto-optical, or optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

To provide for interaction with a user, embodiments of the subject matter described in this specification can be implemented on one or more computers having, or configured to communicate with, a display device, e.g., a LCD (liquid crystal display) or organic light-emitting diode (OLED) monitor, a virtual-reality (VR) or augmented-reality (AR) display, for displaying information to the user, and an input device by which the user can provide input to the computer, e.g., a keyboard and a pointing device, e.g., a mouse, a trackball or touchpad. Other kinds of devices can be used to provide for interaction with a user as well; for example, feedback and responses provided to the user can be any form of sensory feedback, e.g., visual, auditory, speech or tactile; and input from the user can be received in any form, including acoustic, speech, or tactile input, including touch motion or gestures, or kinetic motion or gestures or orientation motion or gestures. In addition, a computer can interact with a user by sending documents to and receiving documents from a device that is used by the user; for example, by sending web pages to a web browser on a user's device in response to requests received from the web browser, or by interacting with an app running on a user device, e.g., a smartphone or electronic tablet. Also, a computer can interact with a user by sending text messages or other forms of message to a personal device, e.g., a smartphone that is running a messaging application, and receiving responsive messages from the user in return.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform the operations or actions. That one or more computer programs is configured to perform particular operations or actions means that the one or more programs include instructions that, when executed by data processing apparatus, cause the apparatus to perform the operations or actions. That special-purpose logic circuitry is configured to perform particular operations or actions means that the circuitry has electronic logic that performs the operations or actions.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of what is being claimed, which is defined by the claims themselves, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claim may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a request to determine whether an input Boolean formula is satisfiable according to a set of satisfiability criteria, wherein the input Boolean formula is a conjunction of a plurality of clauses, wherein each clause is a disjunction of one or more literals;
processing the input Boolean formula using a formula model that is configured to receive, as input, the input Boolean formula, and to generate, as output, a satisfiability probability distribution over assignments of values to the literals in the clauses of the input Boolean formula;
determining whether the input Boolean formula is satisfiable according to the set of satisfiability criteria, comprising, at each of one or more sampling iterations:
sampling, using the satisfiability probability distribution, an assignment of values to the literals in the clauses of the input Boolean formula, and
determining whether the assignment of values satisfies the set of satisfiability criteria; and
in response to determining that the input Boolean formula is satisfiable according to the satisfiability problem, sending, in response to the request, an indication that the input Boolean formula is satisfiable.

2. The method of claim 1, further comprising:
obtaining, for each clause, a respective clause model, wherein the clause model is configured to receive, as input, an input clause of a same length as the clause, and to generate, as output, a respective probability distribution over assignments for the clause.

3. The method of claim 2, further comprising generating the formula model from each obtained clause model.

4. The method of claim 2,
wherein each clause model is a respective Restricted Boltzmann Machine network comprising a visible layer, a hidden layer, and a plurality of parameter values, the visible layer comprising a number of visible units equal to a number of unique literals for a respective clause for the clause model, and
wherein each visible unit in the visible layer is interconnected to each hidden unit in the hidden layer, wherein each interconnection between the visible unit and a respective hidden unit is weighted according to a respective parameter value of the plurality of parameter values.

5. The method of claim 2, wherein obtaining, for each clause, the respective clause model, comprises:
training the respective clause model on a training set of possible assignments for the clause.

6. The method of claim 1,
wherein the formula model has been trained to generate the satisfiability probability distribution that, when sampled,
(i) assigns higher probabilities to assignments that cause the clause to evaluate to true, and
(ii) assigns lower probabilities to assignments that cause the clause to evaluate to false.

7. The method of claim 3, wherein generating a formula model from each obtained clause model comprises:
concatenating each clause model together, including interconnecting each visible unit of each clause model with each hidden unit of each clause model that is not in the clause model of the visible unit.

8. The method of claim 1, wherein generating the satisfiability probability distribution from the formula model comprises processing the formula model across a plurality of hardware accelerators.

9. The method of claim 1, wherein repeatedly sampling assignments of values from the satisfiability probability distribution comprises sampling the assignments using Markov Chain Monte Carlo.

10. The method of claim 1, wherein repeatedly sampling the assignments of values from the satisfiability probability distribution comprises repeatedly sampling the assignments of values in parallel across a plurality of hardware accelerators.

11. The method of claim 1, wherein repeatedly sampling the assignments from the satisfiability probability distribution comprises sampling according to a predetermined annealing schedule.

12. The method of claim 1,
wherein the satisfiability problem is the SAT problem,
wherein determining whether the input Boolean formula is satisfiable according to the satisfiability problem comprises sampling assignments of values from the satisfiability probability distribution until sampling an assignment that causes the input Boolean formula to evaluate to true, or until reaching a predetermined condition; and
wherein the indication that the input Boolean formula is satisfiable comprises a satisfying assignment.

13. The method of claim 1, wherein the satisfiability problem is the MAX-SAT problem.

14. The method of claim 1, wherein the satisfiability problem is the #SAT problem, and wherein determining whether the input Boolean formula is satisfiable according to the satisfiability problem comprises enumerating a plurality of assignments of values that cause the input Boolean formula to evaluate to true by performing the following:
maintaining a list of sampled assignments of values that cause the input Boolean formula to evaluate to true;
whenever sampling an assignment of values that causes the input Boolean formula to evaluate to true, adding the assignment to the list of sampled assignments.

15. The method of claim 12, wherein sampling the assignments of values comprises sampling the assignments using annealed importance sampling.

16. The method of claim 1, wherein the predetermined condition is one of (i) a threshold number of samples from the satisfiability probability distribution or (ii) a predetermined time period, and wherein the method further comprises:
in response to reaching the predetermined condition before determining that the input Boolean formula is satisfiable, sending, in response to the request, an indication that the input Boolean formula is not satisfiable.

17. A system comprising one or more computers and one or more storage devices storing instructions that when executed by the one or more computers cause the one or more computers to perform operations comprising:
receiving a request to determine whether an input Boolean formula is satisfiable according to a set of satisfiability criteria, wherein the input Boolean formula is a conjunction of a plurality of clauses, wherein each clause is a disjunction of one or more literals;
processing the input Boolean formula using a formula model that is configured to receive, as input, the input Boolean formula, and to generate, as output, a satisfiability probability distribution over assignments of values to the literals in the clauses of the input Boolean formula;
determining whether the input Boolean formula is satisfiable according to the set of satisfiability criteria, comprising, at each of one or more sampling iterations:
sampling, using the satisfiability probability distribution, an assignment of values to the literals in the clauses of the input Boolean formula, and
determining whether the assignment of values satisfies the set of satisfiability criteria; and
in response to determining that the input Boolean formula is satisfiable according to the satisfiability problem, sending, in response to the request, an indication that the input Boolean formula is satisfiable.

18. The system of claim 17, the operations further comprising:
obtaining, for each clause, a respective clause model, wherein the clause model is configured to receive, as input, an input clause of a same length as the clause, and to generate, as output, a respective probability distribution over assignments for the clause.

19. The system of claim 18, the operations further comprising generating the formula model from each obtained clause model.

20. One or more non-transitory computer-readable storage media storing instructions that when executed by one or more computers cause the one or more computers to perform operations comprising:
receiving a request to determine whether an input Boolean formula is satisfiable according to a set of satisfiability criteria, wherein the input Boolean formula is a conjunction of a plurality of clauses, wherein each clause is a disjunction of one or more literals;
processing the input Boolean formula using a formula model that is configured to receive, as input, the input Boolean formula, and to generate, as output, a satisfiability probability distribution over assignments of values to the literals in the clauses of the input Boolean formula;
determining whether the input Boolean formula is satisfiable according to the set of satisfiability criteria, comprising, at each of one or more sampling iterations:
sampling, using the satisfiability probability distribution, an assignment of values to the literals in the clauses of the input Boolean formula, and
determining whether the assignment of values satisfies the set of satisfiability criteria; and
in response to determining that the input Boolean formula is satisfiable according to the satisfiability problem, sending, in response to the request, an indication that the input Boolean formula is satisfiable.
